(19) United States
(12) Patent Application Publication
(10) Pub. No.: US 2004/0093261 A1
(43) Pub. Date: May 13, 2004

(54) Automatic validation of survey results

(76) Inventors: Vivek Jain, New Delhi (IN); Ravi Kothari, New Delhi (IN)

Correspondence Address: McGinn & Gibb, PLLC, Suite 304, 2568-A Riva Road, Annapolis, MD, 21401, US

(21) Appl. No.: 10/291,169

(22) Filed: Nov. 8, 2002

(51) Int. Cl. G06F 17/60

(52) U.S. Cl. 705/10

(57) ABSTRACT

The invention describes a method, system and program product for online automatic validation of the survey results that have been conducted online. The invention uses various libraries and tools to analyse the results and conduct new implicit experiments so as to extract more information from the user in order to validate the results of the original survey.

### BACKGROUND OF THE INVENTION

1. Field of the Invention

The invention relates to the field of online survey and data collection systems. More specifically, the invention relates to the automatic validation of the results of these surveys.

2. Description of the Prior Art

The feedback received from surveys and polls often form the basis for improvements in the services and products offered by an organization. Traditionally, the formulation of a survey, its deployment and subsequent analysis of the data obtained from the survey require a considerable amount of time, money and the participation of experts in the field.

With the advent of the Internet, surveys are increasingly being conducted online. Besides the advantages of rapid deployment and a wider audience, online surveys typically require less time and money to administer.

Significant amount of work has been done to allow surveys and polls to be conducted online. However, validation of the results of the survey is still an offline and semi-automatic process that relies on conducting further explicit customer surveys to corroborate the results of the original survey. This semi-automatic validation adds to the cost and sometime may result in biased responses from the participants.

Several factors influence the results of a survey, some of which are:

Error in user response: The response of a user may not be an admissible response. For example, a numeric input when a non-numeric input was expected constitutes an error in the user response. Methods utilizing type checking can be used to ensure that user response conforms to the expected form of the input.

Non-response distortion: The sample of respondents may get distorted due to non-response of some selected participants. Additionally, a user who has a positive disposition towards the surveyor is more likely to participate in the survey than a user who has a negative disposition towards the surveyor. The conclusions from the survey need to be corrected for the non-representative nature of the respondents.

Survey design bias: The phrasing of the questions or the order of choices may bias the response of the user. Rephrased questions and reordered choices may have to be used to neutralize this bias.

Unconscious bias in the user response: The knowledge of participation in an experiment (survey) may bias the responses of the user.

U.S. Pat. Nos. 5,893,098 and 6,175,833 have discussed the method and apparatus to conduct on-line customer surveys and opinion polls respectively. While these methods automate the administration of customer surveys and opinion polls, they do not automate the process of their validation.

WO Patent Application No. 01/67332 discusses targeted online promotions based on previously collected survey responses which may be included in a user profile database. The profile database may be further enriched by observed clickstream behavior, which might complement and validate the information gathered through the questions. The patent application gathers consumer information by soliciting information about the promotion in exchange for rewards. The soliciting of information is an explicit feedback being sought and can indicate the effectiveness of a promotion. The application focuses on updating the profile database through surveys, clickstream tracking and soliciting responses to promotions. The soliciting of information once again makes the methodology susceptible to bias on the user's part. Also the information obtained is not used for validation of results of the original survey. The application mentions “validation” in the passing and does not describe any method or the apparatus to do the same. There are in fact additional forms of validation that encompass issues such as malicious users distorting survey results.

As seen above the disadvantage of the earlier methods are their inability to have an automatic process that validates the results of the survey by conducting experiments that are implicit. In order to have an accurate interpretation of the result so as to reap the real benefit of customer polls and surveys it becomes very necessary to do a proper validation of the results of the online survey. This validation process should be implicit so as to discount the user bias and be automatic so that it is inexpensive and fast.

These issues make validation an important and integral part of the overall survey process.

### SUMMARY OF THE INVENTION

To overcome the above drawbacks and to validate the survey in an accurate and efficient manner, the invention proposes a novel method of validating the results of a survey through a set of implicit experiments. A user is unaware of his or her participation in an implicit experiment making it possible to remove any unconscious bias of the user.

The second objective of the invention is to automate the process of validation.

To achieve the said objectives the invention provides for a method and apparatus for online validation of the results of an online marketing survey (the original survey). The method comprises of conducting an implicit online experiment (the validation survey) to validate the results. A subset of conclusions resulting from the original survey is determined and selected for validation, a research design is selected for validation, users are selected for participation in the implicit experiment and a validation metric is determined. Once the results of the validation experiment are collected and evaluated using the validation metric, the results are reported using a GUI. The validation experiment is designed automatically based on the original survey/experiment design. The whole process of validation is completed online.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative preferred embodiment when read in conjunction with the accompanying drawings, wherein:

FIG. 1 shows the internal structure of the basic computing system on which the invention might be practiced.

FIG. 2 is a flowchart of the validation process.

FIG. 3 is a flowchart explaining how different analytical techniques are used to arrive at different conclusions from the result of the original survey.

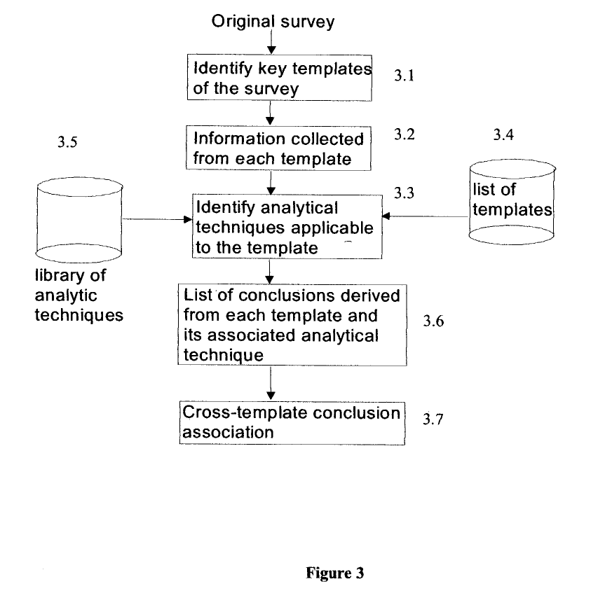

FIG. 4 is a flowchart for the ‘text and analysis tool’.

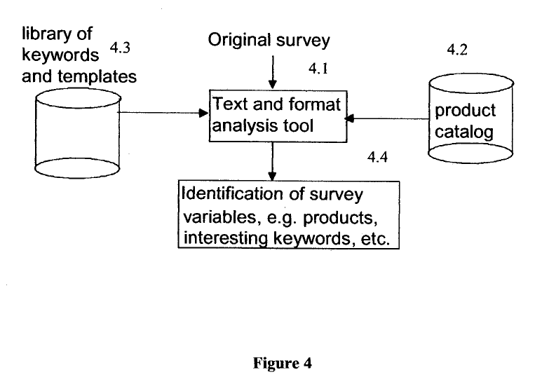

FIG. 5 is a flowchart that shows how cause-effect relationships are determined.

### DETAILED DESCRIPTION

The invention can be practiced on any general computing device as a standalone system or in combination with other similar systems. After the original survey has been conducted and the results are received, they are analysed and validated.

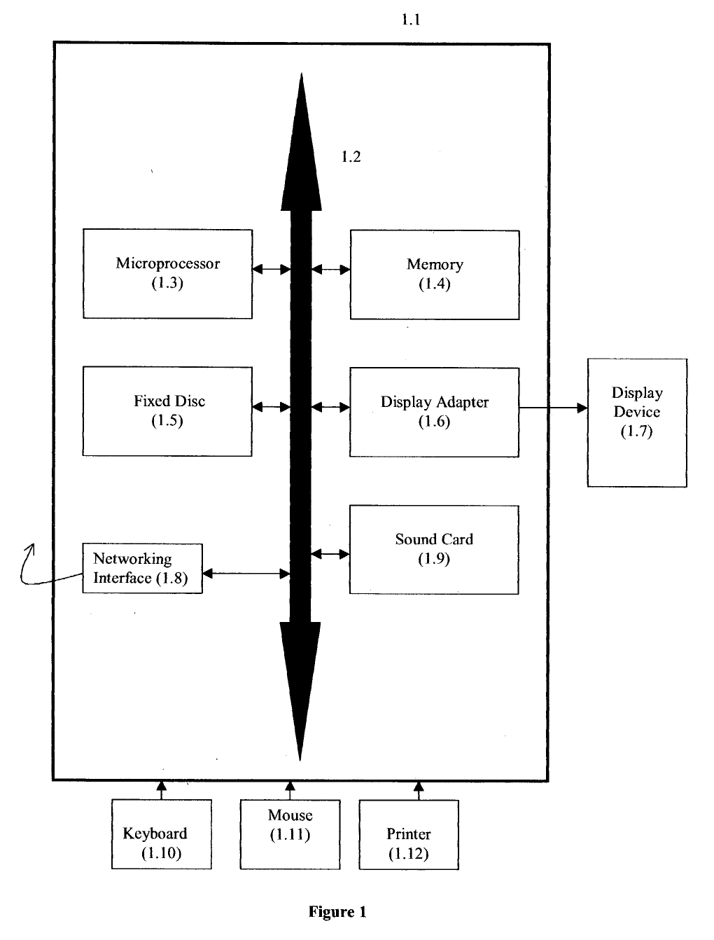

FIG. 1 shows a block diagram of a general computing system (1.1) on which the invention might be practiced. The computer system (1.1) consists of various subsystems interconnected with the help of a system bus (1.2). The microprocessor (1.3) communicates and controls the functioning of other subsystems. The microprocessor (1.3) also acting as the control unit interacts with memory (1.4) to perform operations as defined by the stored instructions. In a general computer system the control module is a microprocessor which could be any commercially available processor of which x86 processors from Intel and 680X0 series from Motorola are examples. The computing system could be a single processor system or may use two or more processors on a single system or over a network. This control module also controls the functioning of the other components of the computing system (not shown). Control module (1.3) accesses said memory (1.4) through system bus (1.2) that interconnects the parts of the computing device. The control module executes a program called the operating system for the basic functioning of the computer system. The examples of operating systems are UNIX, WINDOWS and DOS. These operating systems allocate the computer system resources to various programs and help the users to interact with the system. Memory (1.4) helps the microprocessor in its functioning by storing instructions and data during its execution. Examples are random access memory such as dynamic random access memory (DRAM) or static memory (SRAM). Storage Device (1.5) is used to hold the data and instructions permanent in nature like the operating system and other programs. Video Interface (1.6) is used as an interface between the system bus and the display device (1.7), which is generally a video display such as a monitor. The network interface (3.8) is used to connect the computer with other computers on a network through wired or wireless means. Through the same networking interface, the computer system can also connect to the Internet. The computer system might also contain a sound card (1.9). The system is connected to various input devices like keyboard (1.11) and mouse (1.12) and output devices like printer (1.13), through an input/output Interface (1.10). Various configurations of these subsystems are possible. It should also be noted that a system implementing the present invention might use less or more number of the subsystems than described above.

In the preferred embodiment of the invention, the instructions are stored on the storage device (1.5) in the form of a computer program. This program contains coded instructions for different modules and tools and libraries described herein the specification. On running the program, the instructions are transferred to the memory (1.4) and the microprocessor (1.3) executes the instructions. The system can be manually controlled by giving instructions through means of input devices such as keyboard (1.11) and mouse (1.12). All the instructions whether from the program or from the user input go to the memory (1.4) and are subsequently acted upon by the microprocessor (1.3). The system would also have access to a database (not shown) for various libraries used by the system. This database might reside on the computing system itself or it might be an independent database server. It should be understood that the invention is not limited to any particular hardware comprising the computer system or the software running on it.

Those of ordinary skill in the art will appreciate that the various means for generating service requests by the clients and their processing by the server are instructions for operating on the computing system. The means are capable of existing in an embedded form within the hardware of the system or may be embodied on various computer readable media. The computer readable media may take the form of coded formats that are decoded for actual use in a particular information processing system. Computer program means or a computer program in the present context mean any expression, in any language, code, or notation, of a set of instructions intended to cause a system having information processing capability to perform the particular function either directly or after performing either or both of the following:

a) conversion to another language, code or notation

b) reproduction in a different material form.

The depicted example in FIG. 1 is not meant to imply architectural limitations and the configuration of the incorporating device of the said means may vary depending on the implementation. Any kind of computer system or other apparatus adapted for carrying out the means described herein can be employed for practicing the invention. A typical combination of hardware and software could be a general purpose computer system with a computer program that when loaded and executed, controls the compute system such that it carries out the means described herein. Other examples of the incorporating device that may be used are notebook computers or hand held computers in addition to taking the form of a PDA, web kiosks or even Web appliances.

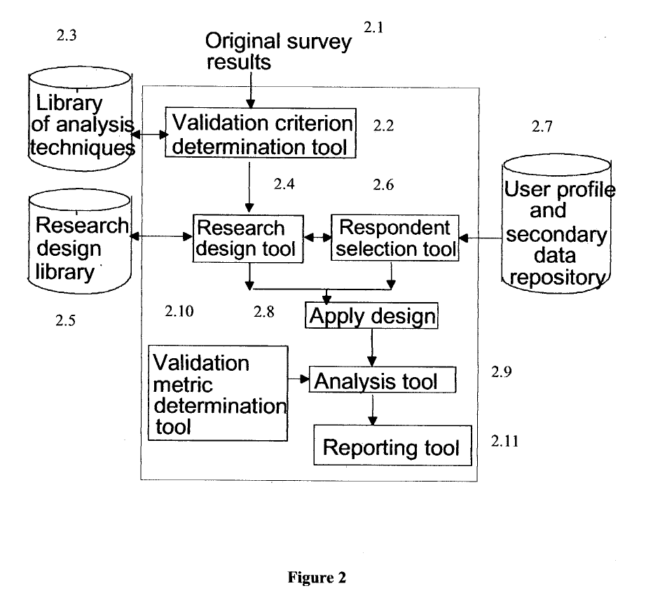

FIG. 2 is a flowchart depicting the functioning of the invention. Given the original survey results (2.1), the validation criterion determination tool (2.2) generates a list of potential conclusions that can be drawn using a library of analytical techniques (2.3). The potential conclusions are sub-divided into smaller subsets for validation. The research design tool (2.4) selects the appropriate conclusion subset for validation and decides on the appropriate experiment to be conducted for validation using a research design library (2.5). The respondent selection tool (2.6), independently or in conjunction with the research design tool (2.4), selects the user(s) on which the validation experiment will be performed. The user profile and secondary data repository (2.7) helps this process. Finally the design is applied (2.8) Results of the (implicit) validation experiments are analyzed by the analysis tool (2.9) using a validation metric as provided by the validation metric determination tool (2.10). The reporting tool (2.11) presents the results.

The various tools that are used in the whole process are explained in detail below:

Validation Criterion Determination Tool

The validation criterion determination tool determines the list of potential conclusions that can be drawn from the original survey. This can be determined in an automated fashion or be guided, in part or in whole, by an outside agent.

A survey consists of series of questions with multiple branches (if response to a question is ‘x’, ask question ‘y’ else ask question ‘z’), question formats (Likert scale, probability of purchase scale, 5 point, 7 point scales), type of variables used (product attributes as identified using the product catalog) and response formats (multiple choice, constant sum allocation, rating, ranking). A library of templates stores frequently used questions grouping, response formats and the instances when they are usually used. Sub-segments from the survey can be identified by matching the original survey with the library of templates (if there is an exact or near exact match with a predefined template) or autonomously through a text and format analysis of the survey design. A text and format analysis tool is used to discover frequently occurring keywords across a multitude of surveys to build a library of keywords and templates. Keywords which are most frequently occurring after removing the stopwords (e.g. Articles, propositions, conjunctions etc.) which occur within a short distance from key products and user specific items are identified. The text analysis tools then automatically associate templates with their respective keywords.

In one instance, a library of templates and its associated variables are mapped to analytical techniques that are available from a library of analytical techniques. Given the results of the original survey, the key templates are first identified (3.1) and information is collected from each template (3.2). Using the library of analytical techniques (3.5) and the list of templates (3.4) it is identified that which analytical techniques are applicable to the template (3.3). The result set is a list of conclusions and its associated analytical technique (3.6). Finally for different templates, a cross-template conclusion association is performed (3.7).

This mapping of analytical techniques to various templates may be specified by the merchant in the form of a look-up table. Also, this mapping can be learnt over period of time from the usage of analysis techniques by the merchant and represented in the form of a table or set of rules. A list of conclusions which are potentially derivable from an analytical technique associated with a survey template with a given format and context of user response, can be derived from previous surveys done with similar formats.

In another instance, cause-effect relationships are autonomously determined by tools such as rule induction, pattern classification, regression analysis which comprise the set of potential conclusions which can be derived. Each survey is associated with a set of features. The set of features are extracted from text and format analysis tool. The steps in classifying the surveys by features like products, and other key phrases used repetitively in the text of the questionnaire have been explained above. A survey can be described by the templates it comprises, keywords which constitute the template, the products of interest used by each template and so on.

The text and format analysis tool (4.1) operates on the results of the original survey. It uses the library of keywords and templates (4.3) and the product catalog for the survey at hand (4.4). Using the information contained in these database, and tools mentioned above, the survey variables are identified.

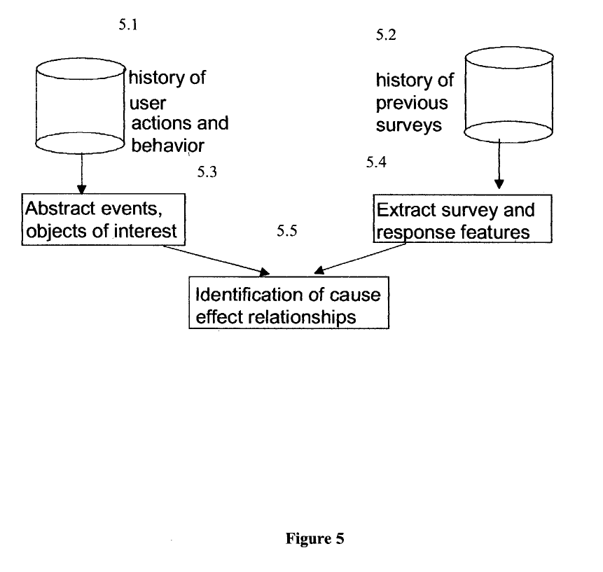

As shown in FIG. 5, cause effect relationships are determined using two database. First of a history of user actions and behavior (5.1) and second of history of previous surveys (5.2). Using these two database, abstract events and objects of interest are determined (5.3) as also survey and response features are extracted (5.4). Using these two result sets, the cause and effect relationships are identified (5.5).

Similarly, User Profile and Secondary Data Repository stores record of user actions and behavior, for example, clickstream behavior, purchase behavior, registration information, advertisement response behavior, coupon response history, survey response history and other user specific information specific to the domain of interest. Events and objects of interest can be abstracted from the user record of action and behavior. An outside agent may guide the process of abstraction or random association may be generated. These candidate events associated with objects of interest are the effects whose relationship with survey features is investigated.

Cause-effect relationships explained above, can autonomously determined by tools such as rule induction, pattern classification, regression analysis. Each cause-effect relationship corresponds to a potential conclusion and represents a candidate for validation. For each of the potential conclusion, a set of Bayesian techniques provide the confidence and support for the potential conclusion. An outside agent may prune or augment the list of conclusions found automatically.

Each conclusion (candidate for validation) is further sub-divided into subsets that are validated individually or in combination with each other. As before, this decomposition can be automated or be guided, in part or in whole, by an outside agent. When the decomposition is done autonomously, tools such as rule decomposition can be used to find the subsets.

Research Design Library

The research design library contains a set of implicit experiments. Each implicit experiment is characterized by the actuation, the possible responses, the procedure for conducting the experiment, and the set of conclusions that can be drawn based on a specific response. For example, the actuation might be “showing a coupon to a user in a specific context (i.e., When he/she is on a specific page, etc.)”. The possible responses are: the user accepts the coupons or the user ignores the coupon. The procedure in this example consists of two steps: offering the coupon and recording the response. The conclusions that can be drawn depend on the user's responses in the original survey. If the user indicated in the survey an intent to buy a product in the next week and them does not accept the coupon, then the conclusion is that the user's time frame or the intent for purchase may be in question.

Library of Analysis Techniques

As shown in FIG. 2, the library of analysis techniques comprises of tools and techniques used for data mining, prediction, learning (supervised and unsupervised), classification, statistical analysis like multivariate regression, maximum likelihood functions, Bayesian estimators and neural network classifiers, analytical tools such as conjoint analysis, discriminant analysis, multidimensional scaling, perceptual maps and brand switching matrix. The library may contain other business intelligence tools like OLAP queries, query joining, etc.

The library has information about input requirements, output result and the performance and/or predictive accuracy of each tool. It may also include an initial map of potential conclusions for a given input and the techniques that can be used to achieve them. The mapping could be stored in the form of a database table, logical rules, decision tree or even a neural network.

Research Design Tool

The research design tool selects the subset of the conclusions to validate (the partitioning of the conclusions into subsets being done by the validation criterion determination tool). The selection of the subset can be done automatically or be guided by input from an outside agent. When the subset is chosen automatically, the subset is chosen based on a score that is assigned on the basis of potential flaws in the original experiment, prior validation experiments, the scope and importance of the conclusions derived from the subset. Correspondence analysis, active learning and other analytic tools can be used for scoring the individual subsets. Once a subset of the conclusions is selected, the research design tool selects the appropriate implicit experiment from the research design library to use for validation the selected subset.

Respondent Selection Tool

The respondent selection tool selects the subjects on whom the implicit experiments will be performed for validation. In one embodiment, the respondent selection tool selects a sub-sample of the original survey participants. The selection of participant users is based on two parameters, the value of the information obtained from the user and the cost incurred by including the user in the approach design. The cost of the user depends on the cost of reaching the user (cost of an advertisement inviting participation), the probability of the user responding and the cost of analyzing and using information collected. The various costs can be computed using secondary data and merchant's domain knowledge. The participant user selection evaluates the potential set of participants along these two parameters and selects the optimal set.

The accuracy of the research output increases incrementally with additional information gathered from each participant. In an instance, the optimal user selection can be based on active learning with an information theoretic criterion based on their profile and its relevance to the implicit experiment. Active learning algorithms based on Bayesian framework provide a measure of information gain from each user's response and can be used as a measure of value of information obtained from the user. In another embodiment, a sample of the respondents may be selected randomly.

Also, some users may not be relevant for implicit experiments. For example, a user who indicated a preference for Sony may have bought a Sony product recently. Such a user is not a good candidate for the implicit experiment since he or she is unlikely to respond affirmatively to an implicit experiment that offers a discount on Sony products. Thus, the profile can be used to guide the selection of the users who will participate in the validation experiments. For example, users for whom

P (Response to the implicit experiment|the preference as expressed in the explicit experiment, profile) is high are good candidates for validation experiments. In the above, P(.) denotes the probability.

User Profile and Secondary Data Repository

The user profile and secondary data repository, is a set of existing information from data banks, government publications, periodicals and books, third-party information resources, prior research reports, prior survey results, prior validation experiment results, past transaction data, etc. It may comprise of on-line as well as off-line data. For example, it may include a of the following:

Information about user demographics, off-line sales transactions and off-line coupon usage records,

Online information on user demographics, purchase history, coupon usage history, and click-stream,

User information regarding usage of products. For example, for a car, the mileage, condition of car at different points in time (say, at the time of servicing), its features, usage occasions, number of travelers in the car relative to the seating capacity, and

History of customer responses to a research design including but not limited to, the presence or absence of response, quality of response and timing of response.

Validation Metric Determination Tool

The validation metric determination tool comprises of a set of validation methodologies, each of which is suitable in a particular context. For each subset of conclusion to be validated and for a particular research design selected to validate the conclusion, there is preferred validation methodology. For example, when the validation (implicit) experiment data is incomplete then a particular methodology can be applied; when the empirical data contains rank ordered information (A is better than B, for example) then a particular methodology can be applied (for example, the Earth Mover's Distance can be used); when the empirical data is numerical in nature then Lp norm (p being determined based on the nature of the experiment) and so on.

For example, if the subset of conclusion to validate the discount at which the user will switch the brand from A to B, and different values of discounts are offered to different users as implicit experiments to validate the conclusion, the validation metric may be a weighted L₂ norm. That is, the RMS of number of respondents buying B, when they are offered a particular discount.

A library of validation methodologies is available which stores the method of computing the validation metric and the specific form of data inputs on which it works best. The validation metric determination tool provides the most feasible list of the validation methodologies to an outside agent who can select one among them. In another instance, the validation metric determination tool autonomously chooses the appropriate methodology given the subset of conclusions to be validated and the choice of the implicit experiment. Each subset of conclusions and the implicit experiment may be described by a set of features and a learning algorithm (including rule induction, pattern recognition) may learn the relationship between these features and the validation metric. Thereafter, the learning algorithm may provide the most preferred validation metric for a given context.

Analysis Tool

The analysis tool uses the metric suggested by the validation metric determination tool to validate the subset of conclusions of the original survey. In the event, multiple subset of conclusions are selected for implicit experiments, the analysis tool combines the result of the validation of each individual subset.

Reporting Tool

The reporting tool aggregates and summarizes the validation process as applied and the results that were obtained. The presentation is made with or without the use of a graphical user interface (GUI). The reporting tool may report validation of each subset and the aggregation in a tree format, with each node representing the aggregation of its child nodes. The tree structure can be build using the validation metric suggested by the validation metric determination tool. The GUI allows the merchant to click on each node and expand the tree to its children or compress the descendants by clicking again on the node. In addition, an outside agent can intervene during the process of validation, by accessing the validation results while the process of validation is on.

It will be apparent to those with ordinary skill in the art that the foregoing is merely illustrative and not intended to be exhaustive or limiting, having been presented by way of example only and that various modifications can be made within the scope of the above invention. For example there might be an incentivisation module added which works in conjunction with the system so as to incentivise users who provide more information in a cost-effective manner. The present invention can be realized in hardware, software or a combination of hardware and software. The service provider as described in the invention could either be realized in a centralized manner, on one computer system or the applications could be spread across several interconnected computer systems. Any kind of computer system or other apparatus adapted for carrying out the methods described herein is suited. A typical combination of hardware and software could be general purpose computer system with a computer program that, when loaded and executed, controls the computer system such that it carries out the methods described herein.

Accordingly, this invention is not to be considered limited to the specific examples chosen for purposes of disclosure, but rather to cover all changes and modifications, which do not constitute departures from the permissible scope of the present invention. The invention is therefore not limited by the description contained herein or by the drawings, but only by the claims.

That which is claimed is:

1. A method for automatically validating the results of an online survey, comprising the steps of:
identifying a subset of potential conclusions from the set of potential conclusions that can be derived from the results of the online survey for validation,
selecting one or more research design tools for validating the selected subsets of potential conclusions either individually or combination,
defining a group of participants for validating a selected subset of potential conclusions and determining the criteria for validation,
applying the research tools on said group of participants for conducting a controlled experiment in a manner that obtains the desired information implicitly,
analyzing the results of each experiment for determining the degree of validation, and
reporting results of the validation.

2. The method as claimed in claim 1 wherein the validation is conducted while conducting the original survey.

3. The method as claimed in claim 1 wherein determining the set of potential conclusions comprises the steps of:
identifying the sub-sets of the survey that match survey templates and keywords in the library of templates and keywords,
mapping identified subsets to analytical techniques present in a library, and/or
determining cause-effect relationships and the potential conclusions associated with each cause-effect.

4. The method as claimed in claim 1 wherein each conclusion is divided into subsets either automatically using tools including rule decomposition or under guidance of an outside agent.

5. The method as claimed in claim 1 wherein the selection of subsets is derived either automatically or guided by an outside agent on the basis of a score that is assigned against parameters including potential flaws in the original survey, prior validation experiments, and the scope and importance of conclusions derived from the subset.

6. The method as claimed in claim 1 wherein the research tool comprises of implicit experiments, each implicit experiment characterized by the actuation of a stimulus, the possible responses, the procedure for conducting the experiment and the conclusions that can be drawn based on the specific response.

7. The method as claimed in claim 1 wherein participants are selected on the basis of parameters including the value of information obtained from the participant and the cost incurred in including the participant in the validation experiment.

8. The method as claimed in claim 1 wherein preferred validation methodologies are defined for each subset of conclusion to be validated and for each research design selected for validating the conclusion.

9. The method as claimed in claim 1 wherein the subsets of conclusions of the original survey are validated using the metrics determined by the validation methodology.

10. The method as claimed in claim 1 wherein the validation results are presented to the user after aggregation and summarisation.

11. The method as claimed in claim 3 wherein the list of conclusions potentially derivable from an analytical technique associated with a survey template of given format and context of user response is derived from similar previous surveys.

12. The method as claimed in claim 3 wherein cause effect relationships are autonomously determined using tools including rule induction, pattern classification, and regression analysis with optional pruning or augmentation by an external agent.

13. The method as claimed in claim 3 wherein various Bayesian techniques provide confidence value and support for each potential conclusion.

14. The method as claimed in claim 5 wherein individual subsets are scored using analytical tools including correspondence analysis and active learning.

15. The method as claimed in claim 7 wherein the participants are chosen using active learning algorithms based on a Bayesian framework to provide a measure of information gain from each user's response.

16. The method as claimed in claim 8 wherein an appropriate methodology for validation is automatically chosen given the subsets of conclusions to be validated and the choice of implicit experiment.

17. The method as claimed in claim 1, wherein an outside agent can accept automatic execution of the steps as enumerated in claim 1 or modify some or all of the steps.

18. The method as claimed in claim 1, wherein said validation results are used to decide the incentive for entities involved with the original survey.

19. The method as claimed in claim 18 wherein said entities include designers of the original survey, participants of the original survey and other agencies associated with conducting the survey, selecting the participants and collecting the response.

20. A system for validation of online survey results comprising:
a validation criterion determination tool for generating a list of potential conclusions and their subsets from the results of the online survey, working in conjunction with a research design tool for selecting appropriate conclusion subset/s for validation,
a library of analytical techniques comprising tools and techniques for data mining, prediction, learning, classification and statistical analysis and other business intelligence tools,
a research design library containing a set of experiments used by the research design tool to decide on the appropriate validation experiment,
a respondent selection tool operating independently or in conjunction with the research design tool to select the participants on which the validation experiment is performed,
a validation metrics determination tool,
an analysis tool for analysing the results of each experiment, and
a reporting tool for providing the results of the analysis.

21. The system as claimed in claim 20 wherein the validation criterion determination tool comprises of a library of templates for online survey design and associated keywords, which are mapped to various analytical techniques available with the library of analytical techniques.

22. The system as claimed in claim 20 wherein the library of analysis techniques includes information about input requirements, the performance and/or predictive accuracy of each tool and an initial map of potential conclusions for a given input and the techniques that can be used to achieve them.

23. The system as claimed in claim 20 wherein the reporting tool is capable of reporting the validation of each subset and the aggregation in a tree format with each node representing an aggregation of its child nodes.

24. The system as claimed in claim 21 wherein the mapping is specified in the form of a look-up table or is learnt over a period of time through repeated usage and represented in the form of a table or set of rules.

25. The system as claimed in claim 22 wherein the mapping is stored in various forms including a database table, logical rules, decision tree and neural network.

26. The system as claimed in claim 20 further comprising of a user profile and secondary data repository.

27. The system as claimed in claim 26 wherein the user profile and secondary data repository comprise of online and/or offline, private and/or public data.

28. The system as claimed in claimed in claim 20 wherein the tools and libraries wholly or partially reside on a computing system comprising of:
a system bus,
a communications unit connected to the system bus,
a memory including a set of instructions connected to the system bus, and
a control unit executing the instructions in the memory for the functioning of the tools.

29. The system as claimed in claim 28 further connected to other similar systems and database systems that may contain the libraries and tools to complement and supplement the already existing tools and libraries present.

30. The system as claimed in claim 20, comprising of an outside agent that can accept automatic execution of the steps enumerated above and comprising of means to modify some or all of the steps.

31. The system as claimed in claim 20 comprising of means to calculate the incentive for entities involved with the original survey using said validation results.

32. A computer program product comprising computer readable program code stores on a computer readable storage medium embodied therein for validation of online survey results comprising of:
computer readable program code means configured for determining the set of potential conclusions from the result of original online survey and for selecting subsets of conclusions to be validate either individually or in combination with each other,
computer readable program code means configured for selecting the research design to validate the chosen subsets of conclusions,
computer readable program code means configured for selecting the participants for said research design experiment and for determining the criteria for validation,
computer readable program code means configured for conducting the implicit experiment, and
computer readable program code means configured for collecting, analysing and reporting the result of the implicit experiment.

33. The computer program product as claimed in claim 32 comprising of computer readable program code means configure for arriving at a set of potential conclusions either automatically or fully or partially guided by an outside agent and means for:
identifying the sub-sets of the original survey that match a survey templates and keywords in the library of templates and keywords, and mapping those to analytical techniques present in a library, and/or
determining cause-effect relationships and the potential conclusion associated with it.

34. The computer program product as claimed in claim 32 comprising of computer readable program code means configured for dividing each conclusion into subsets either automatically using tools including rule decomposition or through partial or full guidance of an outside agent.

35. The computer readable program product as claimed in claim 32 comprising of computer readable program code means configured for automatic or guided selection of subsets and scoring the subsets on the basis of a parameters including potential flaws in the original survey, prior validation experiments, and the scope and importance of conclusions derived from the subset.

36. The computer program product as claimed in claim 32 comprising of computer readable program code means configured for the selection of participants using parameters including the value of information obtained from the participant and the cost incurred by including the participant in the approach design.

37. The computer readable program product as claimed in claim 32 comprising of computer readable program code means configured for validating the subsets of conclusions of the original survey using the metric determined by the validation methodology and means for combining the results of validation of each individual subset, in case of multiple conclusions.

38. The computer program product as claimed in claim 32 comprising of computer readable program code means configured for presenting the validation results to the user after aggregation and summarisation.

39. The computer program product as claimed in claim 32, comprising of computer readable program code means configured for accepting automatic execution of the steps as enumerated above and computer readable program code means configured for modifying some or all of the steps.

40. The computer program product as claimed in claim 32 comprising of computer readable program code means configured for deciding the incentive for entities involved with the original survey using said validation results.
